(19) United States
(12) Patent Application Publication
(10) Pub. No.: US 2007/0055663 A1
(43) Pub. Date: Mar. 8, 2007

(54) Programmatic response for detected variants of HTTP requests

(75) Inventors: Mark C. Hancheroff, Bellevue, WA (US); Rebecca A. Olsen, Renton, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/217,489

(22) Filed: Sep. 2, 2005

(51) Int. Cl. G06F 17/30

(52) U.S. Cl. 707/6

(57) ABSTRACT

A method and system to programmatically respond to detected variants associated with requests are provided. Data files are generated to respond to subsequent instances for the requests. Each request is checked to determine the variants. A combination of variants included in each request specifies a response type. Flat files are cacheable versions of requested data that implement the variant combinations associated with the request. After the variants in subsequent requests are detected, a response that is identical to the initial response to a previous request having a similar variant combinations is generated. The generated response to the subsequent request may include redirection to a flat file, modification of data files, or other appropriate actions.

### CROSS-REFERENCE TO RELATED APPLICATION

Not applicable.

### STATEMENT REGARDING FEDERALLY SPONSORED RESEARCH OR DEVELOPMENT

Not applicable.

### BACKGROUND

Currently, intelligent web pages include code and scripts that allow content of the web pages to be rendered based on variants associated with a computer requesting the intelligent web page. Requests to display the intelligent web pages execute the scripts at page rendering time to dynamically alter the content. Additionally, the variants associated with the computer requesting may trigger the intelligent web page to perform actions, such as file manipulation or cookie creation. When the computer that generates a request for the intelligent web page is outside a geographic region associated with the intelligent web pages, the computer experiences substantial performance and latency degradation.

For instance, the intelligent web page may implement a language variant that supports forty different languages, such as French, Dutch, etc. The intelligent web page is rendered using the appropriate language selected by the language variant script. The language variant script renders the intelligent web page according to the language variant that detected from the operating system, or browser version, etc. The language script is executed for each intelligent web page request at page-rendering time. Executing the script at page-rendering time increases response time associated with delivering the intelligent web page requested by the user increases and hampers performance, when multiple users from different geographic locations access the intelligent web page. Moreover, delivery of the intelligent web page may not be optimized or cached because the language variants detected by the language script associated with the intelligent web page dynamically alters the content rendered by the intelligent web page.

### SUMMARY

A variant detection engine tests requests to determine the variants associated with the requests. The variant detection engine determines an action to perform based on results of the tests. The variant detection engine may generate a cookie and timestamp the cookie depending on the variants associated with the request. When the cookie is timestamped, subsequent requests that include similar variants may utilize the cookie to bypass some of the tests associated with the requests. When the variant detect engine utilizes the cookie, response time associated with the subsequent requests is reduced. Moreover, multiple installations of the variant detection engine may be deployed to different remote geographic locations to improve reliability and quality of service, and to reduce latency associated with requests from the different remote geographic locations.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates a block diagram of an exemplary computing environment utilized by embodiments of the invention;

FIG. 2 illustrates a component diagram of a variant detection engine utilized by embodiments of the invention;

FIG. 3 illustrates a variant detection data structure utilized by the variant detection engine, according to embodiments of the invention; and

FIG. 4 illustrates a flow diagram of a method to detect variants implemented by the detection engine, according to embodiments of the invention.

### DETAILED DESCRIPTION

Embodiments of the invention provide a variant detection engine to process requests. The variant detection engine utilizes a variant data structure having a hierarchical representation of variants associated with a location specified in the requests. The requests are tested to determine the variants associated with the requests, and responses are generated to allow subsequent requests to bypass some of the tests that were performed on an initial request. Additionally, embodiments of the invention utilize intelligence extracted from intelligent web pages via mapping data structures that are associated with services or flat files. The flat files are cached and responses are generated to optimize the delivery of the flat files implementing the variants.

A computing environment utilized to implement embodiments of the invention may include a collection of client and server computers. The client and server computers may include multi-processor computers and portable computers. The portable computers may include laptops, personal digital assistants, smart phones, etc. The client or server computers may include databases that store data and provide interfaces to access the data. The server computers are computers that are accessed over a communication network and may include search engines that provide access to the databases stored on the server computers. The client and server computers each have processing units, coupled to a variety of input devices and computer-readable media via communication buses. The computer-readable media may include computer storage and communication media that are removable or non-removable and volatile or non-volatile. By way of example, and not limitation, computer storage media includes electronic storage devices, optical storages devices, magnetic storage devices, or any medium used to store information that can be accessed by client computers, and communication media may include wired and wireless media. The input devices may include, mice, keyboards, joysticks, controllers, microphones, cameras, or camcorders, picture phones, or any suitable device for providing user input to the client computers. The client computers communicate with the server computers over a communication network. The communication network may be a wireless network, a local area network, a wide area network, or the Internet.

The server computers may include web servers that provide access to intelligent web pages and flat files, flat web pages, or services, such as, data retrieval, image selection, etc. In an embodiment of the invention the intelligent web pages are centrally located and the flat web pages are related to the intelligent web pages and are distribute throughout the network based on variants associated with the intelligent web pages. Flat files may implement one or more flat web pages and one or more services based on the variants includes in the intelligent web pages. The services may include Hypertext Transport Protocol (HTTP) services. In an embodiment of the invention, requests include HTTP request, requests for a document, image, movie, or a request to perform an action.

In an embodiment of the invention, variants may include browser version or type, operating system version or type, and cookies, language, time zone, geographic location, etc. An intelligent web page is a web page that dynamically renders the content associated with the intelligent web page based on the variants detected by a script contained associated with the web page. The intelligent web pages are not cacheable. Variants may be detected via helper applications or data stores. In an embodiment of the invention, requests may be geographically grouped based on reverse internet protocol (IP) address detection. Accordingly, all users from a specified region may share similar rendering experiences, regardless of information associated with computers that generated the requests. For instance, rendering content to user from England and France may generate different content, where users from France receive content different from content sent to users from England.

A flat web page is a specialized flat file implementing a web page that does not dynamically alter content, and stores static content that relates to an intelligent web page. Unlike the intelligent web pages, the flat web page are cacheable. For instance, an intelligent webpage supporting language variants, such as, French, English, or Dutch may generate a flat web page in French, when a request for the intelligent page includes the language as variant that the client computer sets. The flat web page generated in French may be stored for future use by a user requesting the French language variant.

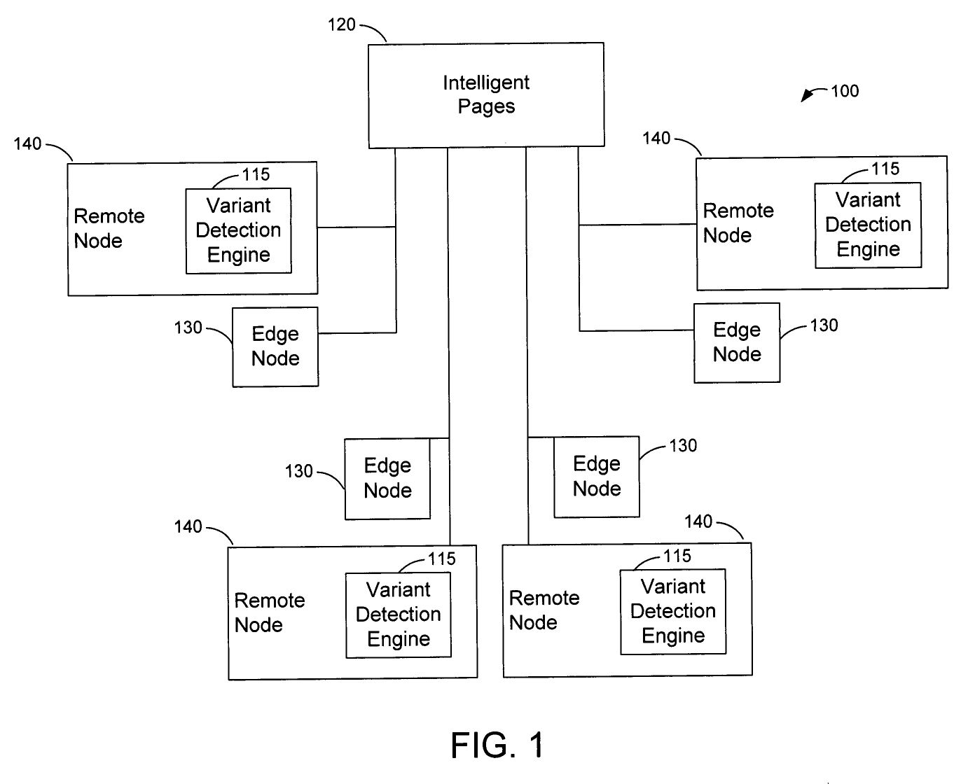

FIG. 1 illustrates a block diagram of an exemplary computing environment 100 utilized by embodiments of the invention. The computing environment 100 is not intended to suggest any limitation as to scope or functionality. Embodiments of the invention are operable with numerous other special purpose computing environments or configurations. With reference to FIG. 1, the computing environment 100 includes, variant detection engines 115, edge nodes 130, remote nodes 140 and intelligent web pages 120.

The nodes 130 and 140 represent computing devices that process or store web page information. The remote nodes 140 provides access to the intelligent web pages 120 and includes variant detection engines 115. The decentralized distribution of web page information related to the intelligent web pages 120 allows the remote nodes 140 to protect the core data related to the web page information. Furthermore, the remote nodes 140 may issue self-contained updates to edge nodes 130 that store web page information related to the intelligent web pages.

The variant detection engines 115 receives requests for intelligent web pages 120. The variant detection engine 115 performs a specified collection of pre-action processing tests on the requests to decide where the requests should be routed. After the pre-action processing tests are preformed on the requests, flat web pages and cookies may be generated to efficiently process subsequent requests for the intelligent web pages 120. The flat web pages are distributed to edge nodes 130 based on the variants detected in the requests. Cookies may be stored on a user's computer to return a response without having to reiterate all tests for the subsequent requests. Accordingly, the variant detection engine 115 reduces response time delays associated with rendering the intelligent web pages 120. In an embodiment of the invention, the variant detection engine 115 is implemented by dynamic linked libraries (DLL) and XML files.

The intelligent web pages 120 includes dynamic content that is rendered depending on the variants associated with the intelligent web pages 120. The intelligent web page 120 includes one or more pre-determined variances, such as, internet protocol (IP) address, language, or cookies. Additionally, the intelligent web pages include one or more scripts or programming code to alter content dynamically.

The edge nodes 130 store web data associated with the intelligent web pages 120. The web data may include flat web pages generated by the central node to implement one or more of the variants implemented by the intelligent web page based on the variants associated with requests generated by the remote nodes 140. The generated flat web pages are distributed to the edge nodes 130 utilizing the variants associated with the requests. In an embodiment of the invention, the flat web pages are sent to edge node 130 having proximity to the remote nodes 140 that generated the requests.

The remote nodes 140 pass the requests for the intelligent web pages 120. The requests may include variant and location information. The variant information may specify variants that must be implemented and the location information specifies the location of the intelligent web pages. For instance, a language variant included in the requests for the intelligent web pages 120 that implements the language variant is detected by the variant detection engine 115. The remote nodes 140 utilize the variant detection engines 115 to determine which version of the content of the intelligent web pages 120 should be served from the edge nodes 130. If the request was previously generated, the edge nodes 130 stores a flat web page that implements the language variant associated with the requests. Otherwise, the variant detection engine creates a cookie or other client-stored identification to return a response without having to reiterate all tests for subsequent requests. In an embodiment of the invention, the subsequent requests are redirected to a flat file that implements one or more services and variants associated with the intelligent web page 120.

In an embodiment of the invention, the remote node 140 stores cookies containing information that may be utilized to retrieve the flat web pages associated with intelligent web pages 120 specified in the request. The cookies provide information about the variants when the flat web pages implements variants associated with the intelligent web pages 120. Moreover, the remote node 140 may cache the flat web pages for a specified time period after the flat pages are generated, and the cookie may provide information about the specified time period.

In an alternate embodiment of the invention, the remote nodes 140 and edge nodes 130 may be combined and implemented together across multiple machines. The computing environment illustrated in FIG. 1 is exemplary and other configurations are within the scope of the invention.

The variant detection engine 115 includes components that store the criteria for tests associated with the variants and code that implement the tests. The test component may store the criteria based on the variants associated with the intelligent web pages. The criteria may be stored in a hierarchical tree that creates nested criteria to represent complex relationships between criteria for the tests. In an embodiment of the invention, the detection engine extracts the intelligence from the intelligent web page to create the nested criteria in the hierarchical tree. The requests for the intelligent web pages include intelligence and location information for the intelligent web page. The intelligence may include data that specifies the variants that the user wants. The code component provides the implementations that execute the tests associated with the hierarchical tree. The code component implements recursive tests on the criteria passed from the test component. The requests received from a remote node may include variants that the variant detection engine processes utilizing the test and code components to decide how the requests should be handled. The variant detection engine may generate response, such as, for example, a cookie, redirect, or transfer based on the requests received for the remote node.

In an embodiment of the invention an administrator may modify the criteria to add or remove tests. The hierarchical tree of criteria may include tests that were not detected in the intelligent web page. The variance detection engine may utilize the modified hierarchical tree to filter requests that include variants that a page does not support. For instance, when a language variant, such as French is no longer supported by the intelligent web page the administrator may modify the hierarchical tree to reflect this change. Thereafter, a user requesting the page with the variants included in the removed variants would bypass that variant, and proceed to a subsequent test. An administrator from France, could modify the hierarchical tree to always provide English content on a web page in French.

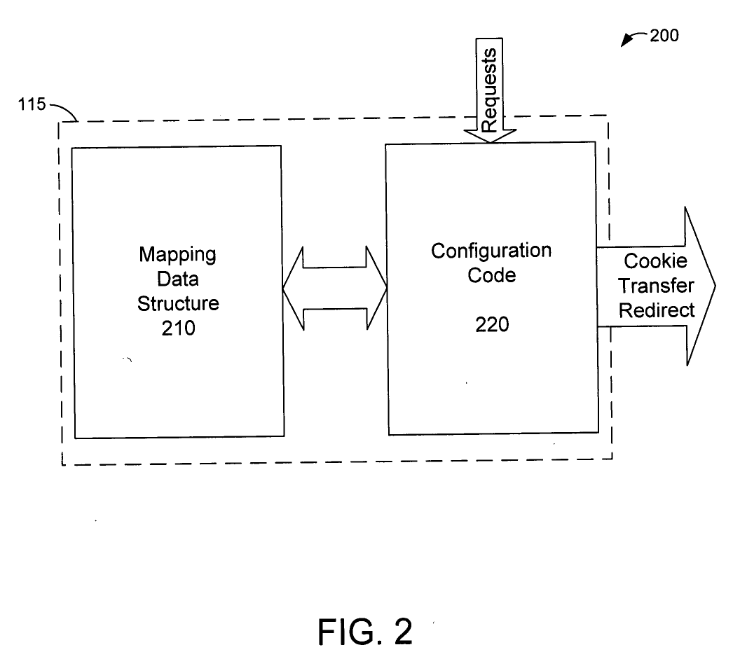

FIG. 2 illustrates a component diagram 200 of the variant detection engine 115 utilized by embodiments of the invention. The variant detection engine 115 includes mapping data structure 210 and configuration code 220. The configuration code 220 is communicatively connected to the mapping data structure 210 and may be implement by one or more DLL files. The mapping data structure 210 passes criteria to the configuration code 220 to test requests sent to the variant detection engine. The configuration code 220 parses the requests to determine the response associated with the requests. The variants included in the requests are communicated to the mapping data structure 210 to determine the tests that should be executed on the variants. The tests associated with the variants are communicated to the configuration code 220, and the configuration code runs the tests on the requests to determine which response action to take. The response action may include redirect, transfer or generate a cookie, time stamp the cookie, etc.

The mapping data structures describe host information, such as, which host headers are being mapped along with default information utilizes to timestamp a cookie. The mapping data structure also include testing criteria that provides information on what type of tests to run on the request. For, instance the criteria may specify to run a test when a page name is “default.aspx.” or test a querysting having a specified value. Moreover, the mapping data structure specifies the appropriate response action based on the results of the test, whether to run additional recursive tests, redirect, cookie stamp, etc.

After extracting intelligence from the intelligent web pages, the mapping data structures are created to store the intelligence and provide a description of how to process the variants included in the requests. The mapping data structures 210 describe the locations associated with a site, such as, the intelligent web pages. The location information may include uniform resource identifier or locators (URI or URL).

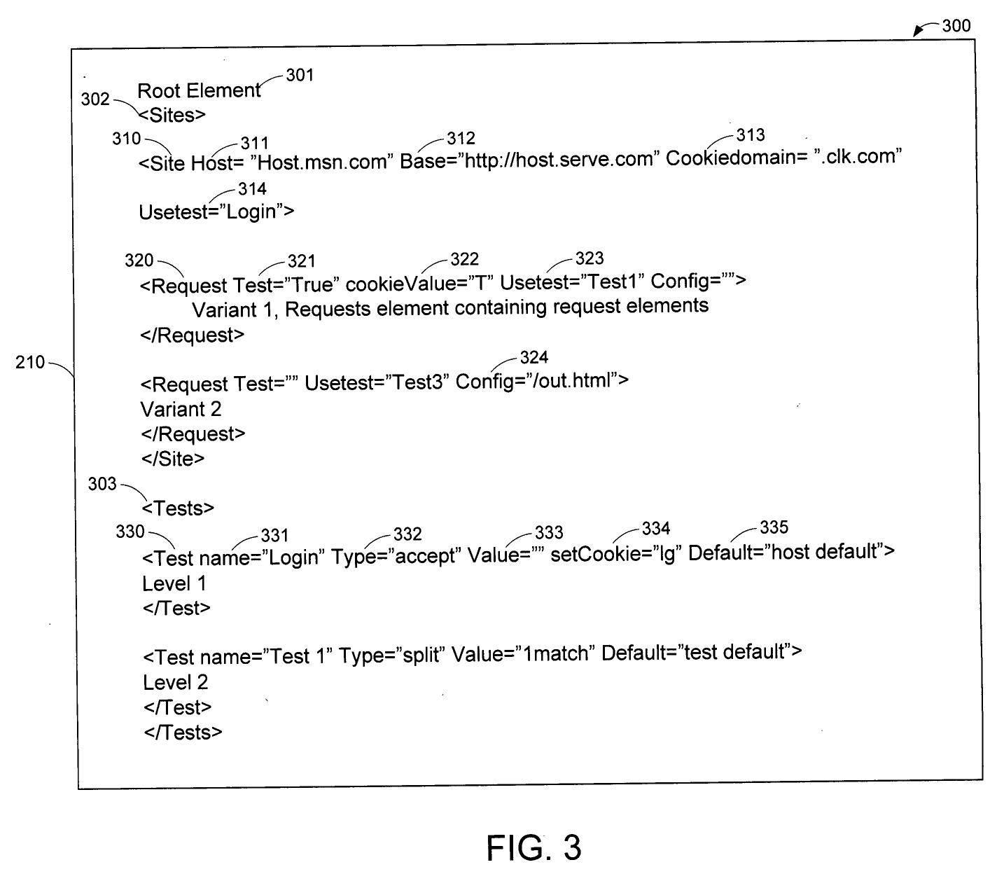

FIG. 3 illustrates a variant detection data structure 300 utilized by the variant detection engine, according to embodiments of the invention. In an embodiment of the invention, the variant data structure 300 is the mapping data structure 210 in XML file format that may be stored in the memory of the remote node. With reference to FIG. 3, the variant detection data structure 300 includes root, a sites, tests, site, request and test elements 301, 302, 303, 310, 320 and 330. In an embodiment of the invention, each element 310, 320 and 330 contains one or more attributes that specify values associated with the elements 310, 320 and 330.

The root element 301 contains sites element 302 and tests element 303. The sites element 302 contains one or more site elements 310, and the tests element 303 contains one or more test elements 330. The site elements 310 include location, test and destination information. In an embodiment of the invention, the location and test information are specified by attributes associated with the site element 310. The host, base, cookiedomain, and usetest attributes 311-314 provide values for location and test information for the content associated with the site element 310. The host attribute 311 provides information to describe the location of a site, such as a server. The base attribute 312 provides information to describe location information associated with a destination address. In an embodiment of the invention, the base attribute 312 includes URL information that is pre-pended to responses associated with requests for the site. The cookiedomain attribute 313 provides location, domain, information for any cookie being stored on a client computer as a result of a test executed on the request. The domain information is utilized to allow a server to access the cookie at a later time. The usetest attribute 314 provides the name of the first test to use and maps to a test element 330, which describes the criteria to utilize when running the test.

The request element 320 provides more information about the destination address storing content associated with the request based on the attributes associated with the request element 320. The request element 320 further provides information about tests to run on segments of the request. The request element 320 may be a child element of the site element 310 or of a requests element (not shown) and includes test, cookievalue, usetest and config attributes 321-324. The request element 320 is a nested element that defines the variants or requests for the web page. The test attribute 321 provides a value to match the result of a parent test, which may be the result of the test specified by the site usetest attribute 314 or a result of a test specified by the request usetest attribute 323. The cookie value attribute 322 provides a value to stamp into the cookie name defined in the test element 330 with the cookiedomain specified in the site element 310. The usetest attribute 323 provides the name of subsequent test and criteria to utilize when running the test on the request, if necessary. The config attribute 324 provides a value to append to the base attribute 312, to create a destination address. In an embodiment of the invention, when the config attribute 324 is utilized, no further test will be executed on the request.

The test element 330 provides information to execute the tests specified in the site and request elements 310 and 320. The test element is a child element of the tests element 303. The test element 330 defines, among other things, default values utilized to respond to the requests, when the requests are not described by the variant data structure 300. The test element 330 includes name, type value, setcookie and default attributes 331-335. The name attribute 331 provide the names for the tests implemented the configuration code. The names may be utilized by the site and request usetest attributes 314 and 323 to call the tests in the configuration code. The type attribute 332 specifies the type of test performed, such as, accept, split, querystring, or cookie. The value attribute 333 provides additional data needed to execute the tests. The additional data may include the value of a querystring, cookie name, or other data needed by the configuration code to execute the tests. The setcookie attribute 334 describes the name of a cookie to be stamped as a result of the test. The default attribute 335 provides a test result that is returned, when an error occurs or when the requests for the intelligent web page do not match the requests described by the variant data structure 300. In an embodiment of the invention, the set cookieattribute 334, if specified, either allows the result of a test to be stamped to the specified cookie, or overridden by a value specified in the cookie value attribute 322.

Accordingly, the variant data structure 300 provides division logic utilized to parse the requests received by the variant detection engine. The variant data structure 300 provides test options associated with the requests and builds the destination address, which may be the location of one or more flat web pages associated with the intelligent web pages specified in the request. The flat web pages may be cached on the edge nodes, and redirects to the flat web page are stored in the variant data structure to optimize the delivery of the flat web pages implementing one or more variants associated with the request.

Configuration code may be utilized by the variant detection engine to determine configuration values including default behaviors and a location of a mapping data structure. In an embodiment of the invention, the intelligent web pages include a set of predetermined variants, such as IP, language, cookie, etc. The flat pages are generated to implement one or more of the variants associated with the intelligent web pages. The mapping data structures provide test information associated with each intelligent web page, and receive the request, including one or more variants, for the intelligent web page. Also, the mapping data structures perform variant look-ups, utilizing the variant detection engine, to determine the tests to execute on the requests based on the different variants specified in the user's request for the intelligent web pages. The configuration code provides the variant detection engine with the appropriate settings. After the variant detection engine has traversed the mapping data structure to locate the variants, destination addresses for the flat pages associated with the variants are generated, if matching variants are implemented by the intelligent web page. If there is an error or no matching variants, the user is provided with a generic experience associated with the intelligent page. In an embodiment of the invention, the variants may be included in a querystring attribute associated with the tests, which are passed to the configuration code to generate a redirect URL.

A user may generate the request manually or by clicking on a link having the variants associated with the link. The variants included in the request dynamically map to one or more flat web pages that are cached based on the variants included in the request. The requests received by the variant detection engine may generate response information that includes the location of the flat web pages. The response information is created after receiving one or more user requests. The flat web pages that were generated from the intelligent web pages are cached based on an initial request for the intelligent web page. Also, after receiving the initial request the mapping data structure associated with the intelligent web page is created utilizing the variants implemented by the intelligent web page. In an embodiment of the invention, the flat web pages are cached at one or more edge nodes based on the location of the user performing the initial request. Accordingly, when the variant detection engine reads the variants associated with subsequent request for the intelligent web page, the response is a redirection to the edge node storing the flat web pages, otherwise a default page is provided.

The mapping data structure provides information that specifies the tests to run for the site, page or variants included in the request. The mapping data structure allows the variant detection engine to bypass predetermined variants and tests based on information associated with the request. The configuration code includes an httphandler that listens for the requests and directs them to the variant detection engine to determine, among other things, the site and the variants associated with the request. The variant detection engine includes code to implement the tests associated with the variants specified in the mapping data structure. For instance, an IP address variant may be specified in the requests, and the mapping data structure may include a test for the IP variant specified in the request. The variant detection engine may execute the test associated with the IP address variant by determining the location associated with the IP address and returning a reference to the flat page stored on an edge node associated with the location. The variant detection engine communicates with the configuration code to obtain the correct settings and recursively performs tests or checks on the different variants as specified in the mapping data structures, until no additional test are required. The user receives either the destination of the flat web pages associated with the variants or a default page.

In an embodiment of the invention, communication between the configuration code, variant detection engine, and mapping data structures includes, the configuration code receiving one or more requests and initiating the variant detection engine which performs a variant look-up utilizing the mapping data structures. In response, the mapping data structures provide the tests to perform on the one or more requests based on the variant look-up, and the variant detection engine performs the tests on the one or more requests to return a destination web page. The destination web page may be a default page, a flat web page, or some other action, such as setting a cookie associated with request and the variants.

Cookie stamping provides the variant detection engine with information on how to deal with subsequent requests that ask for similar information that is specified by the cookie. The cookie, if utilized, includes a value that is utilized by subsequent requests. The cookie may include the result of a particular test, or a value mapped based on the result of a test. Additionally, data files may be stored on client computers that store response information. The data files may be timestamped to determine when the file expires.

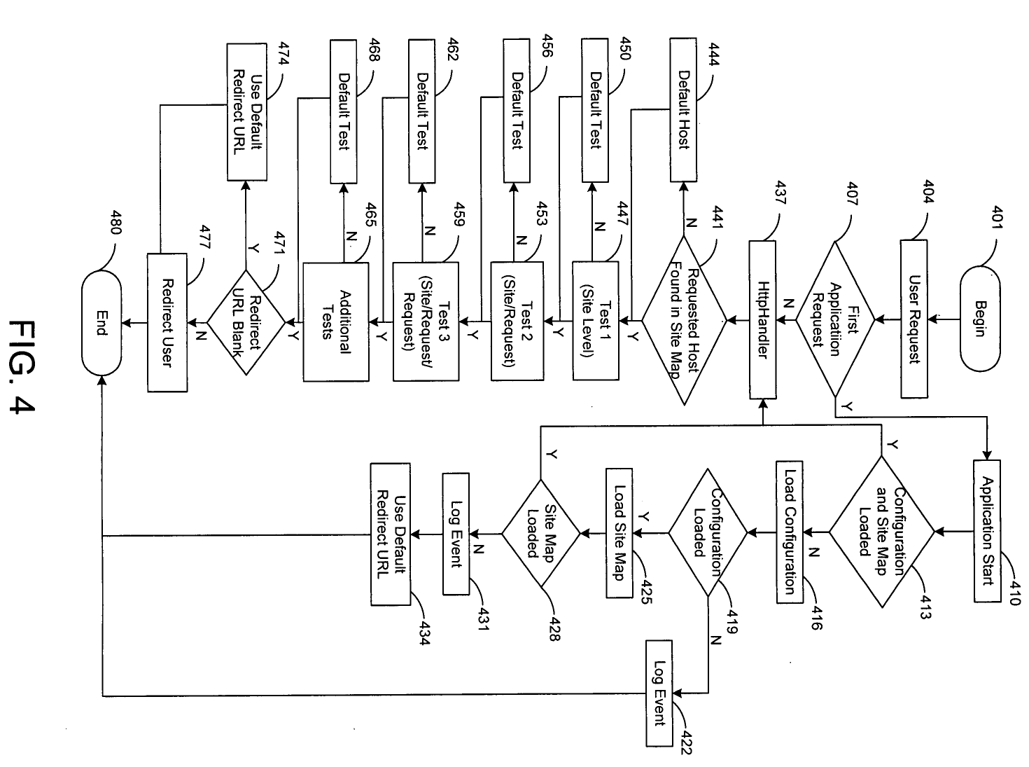

FIG. 4 illustrates a flow diagram 400 of a method to detect variants implemented by the variant detection engine, according to embodiments of the invention. In an embodiment of the invention, the variant detection engine, configuration code and mapping data structures are define by a DLL, CONFIG and XML files, respectively.

The method begins in step 401. The variant detection engine receives a request for one or more intelligent pages from the user in step 404. A check is made in step 407 to determine whether the user request is new request.

If the request is a new request, the variant detection logic and code, including the site maps and configuration code, are initialized in step 410. A check is made in step 413 to determine whether the mapping data structures and configuration code associated with the variant detection logic and code are loaded in memory. If the configuration code and mapping data structures are loaded, the method returns to step 437 to parse the user request. If the configuration code and mapping data structures are not loaded in memory, a load operation for the configuration code is performed in step 416. In step 419 a check is made to determine whether the configuration code is successfully loaded. If the configuration is successfully loaded, a load operation for the site map is performed in step 425. In step 428 a check is made to determine whether the mapping data structures are loaded successfully. If the mapping data structures are successfully loaded, the method returns to step 437 to parse the user request. If the mapping data structures are not loaded successfully, a fail mapping data structures load event is generated and logged in step 431 and a default redirect URL is returned to the user as a response in step 434. If the configuration code was not successfully loaded, a fail configuration code load event is generated and logged in the event log in step 422 and the method ends in step 480.

If the request is not the first application request, the user request is passed to the httphandler for parsing in step 437 to generate a response, such as, a redirect URL or action. In step 441 a check is made to determine whether the site information associated with the user request matches the site information included in the mapping data structures. If the site information match does not match, a default host is utilized in step 444 and the method continues with the other recursive test that tests the user request for further matches in step 447. If the site information matches, a site level test, “test 1,” is performed in step 447. If the user request passes “test 1,” “test 2” and “test 3” are run on the different segments of the user request in steps 447, 453 and 459 until no additional recursive tests are available. If the request fails “test1,” “test 2” or “test 3,” default test values 450, 456 and 462 are utilized to create a redirect URL. In step 465 additional recursive tests may be executed on the segments of the user request and default values are provided when the user request fails the additional recursive test in step 468. After performing all the recursive tests 447, 453, 459 and 465 on the user request, the redirect URL is generated by combining the results received from each recursive test. In step 471 a check is made to determine whether the redirect URL is blank. When the URL is blank the default redirect URL is utilized in step 474 and the user is redirected to the default page in step 477. If the redirect URL is not blank the user is redirected to the URL specified in the generated redirect URL, which may be the location of an edge storing one or flat pages. The method ends in step 480.

Accordingly, the tests performed on the request allows the variant detection engine to programmatically generate a response based on the variants included in the request.

In sum, providing distributed delivery of core data and self-contained variant detection implemented utilizing a variant detection engine, reduces bottlenecks associated with rendering intelligent pages. Executing tests on requests for the intelligent pages generated redirects to flat files stored on one or more edge nodes. The edge node distribution provides performance and processing efficiencies. The tests executed on the requests are atomic and may be chained together to generate an output page that implements the variants included the request. The variant detection engine reads one or more headers to traverse a hierarchical criteria to determine the correct tests to execute on the request. Accordingly, the variant detection engine, separates the detection of variants from the generation and delivery of the page. This allows each variant associated with the intelligent web pages to be cached and delivered with minimal costs to the computing environment. The variant detection engine provides responses, which may be utilized to retrieve intelligent HTFP requests normally generated by dynamic code from static locations storing static version of the intelligent web pages.

Alternate embodiments of the invention provide a data structure that provides access to tests that generate redirect URLs. The data structure includes test information, and attribute information to define the tests associated with segments of a request received from a remote node. When a segment of the request matches one or more test criteria included in the data structure, a portion of the redirect URL is generated. If the segments of the request successfully pass the test the redirect URL will provide a reference to flat pages that implement the variants associated with the request. Otherwise, the redirect URL references a default page.

The foregoing descriptions of the invention are illustrative, and modifications in configuration and implementation will occur to persons skilled in the art. For instance, while the present invention has generally been described with relation to FIGS. 1-6, those descriptions are exemplary. Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing the claims. The scope of the invention is accordingly intended to be limited only by the following claims.

We claim:

1. A method to detect variants associated with requests, the method comprising:
receiving a request including variants and location data;
parsing the request to determine the variants; and
generating a response based on the variants included in the request.

2. The method according to claim 1, wherein generating the response based on the variants included in the request, further comprises:
loading a detection file associated with the location data, and
recursively testing the request including variants and location data utilizing test criteria included in the detection file.

3. The method according to claim 1, wherein generating the response, if the variants in the detection file match the variants in the request, further comprises:
creating cookies or data files to store the variants detected and time stamping the files.

4. The method according to claim 3, wherein subsequent requests having similar variants and location data utilize the cookies to bypass one or more tests.

5. The method according to claim 1, wherein generating a response based on the variants included in the request, further comprises:
programmatically generating the response.

6. A computer system to detect variants, the computer system comprising:
one or more remote nodes to pass requests including one or more variants;
an intelligent web pages implementing at least one variant; and
one or more edge nodes to store flat files associated with the intelligent pages.

7. The computer system according to claim 6, wherein the remote node includes a detection engine to test the requests.

8. The computer system according to claim 7, wherein the detection engine maps the variants to the flat files requests stored on the one or more edge nodes.

9. The computer system according to claim 7, wherein the detection engine includes a database to store a variant and a URL implementing the variant.

10. The computer system according to claim 8, wherein the detection engine creates a data file to store the location of the flat files.

11. The computer system according to claim 9, wherein the database includes a hierarchical tree of tests.

12. The computer system according to claim 11, wherein the data file is time stamped by the detection engine.

13. A method to generate responses based on one or more variants, the method comprising:
testing a request for a HTTP request;
detecting one or more variants in the HTTP request;
generating and storing one or more flat files associated with the variants;
receiving a subsequent request for the HTTP request; and
redirecting the subsequent request for the HTTP request to the one or more flat files.

14. The method according to claim 13, wherein the HTTP request is an intelligent page.

15. The method according to claim 13, wherein testing the request for the HTTP request further comprises:
traversing a hierarchical tree.

16. The method according to claim 13, wherein default data is returned, if the one or more variants are not detected.

17. The method according to claim 13, wherein redirecting the subsequent requests for the HTTP request further comprises:
redirecting or transferring a URL of the web page to a URL for a flat page.

18. The method according to claim 13, wherein a cookie or data file is generated to store redirect information.

19. The method according to claim 18, wherein the cookie or data file expires after a specified time period.

20. A computer system having memory and a processor to implement the method as recited in claim 13.
